(19) United States
(12) Patent Application Publication
(10) Pub. No.: US 2025/0077260 A1
(43) Pub. Date: Mar. 6, 2025

(54) METHOD AND SYSTEM FOR DETECTING CPU SMT TOPOLOGY BY EXPLOITING SHARED RESOURCE UTILIZATION

(71) Applicant: Citrix Systems, Inc., Fort Lauderdale, FL (US)

(72) Inventors: Ioannis Prevezanos, Patras (GR); Ioannis Dounis, Nafpaktos (GR); Ioannis Beredimas, Thessaloniki (GR); Shankar Krishnamurthy, San Ramon, CA (US)

(21) Appl. No.: 18/467,427

(22) Filed: Sep. 14, 2023

Related U.S. Application Data
(63) Continuation of application No. PCT/GR23/00045, filed on Aug. 31, 2023.

(51) Int. Cl. G06F 9/455

(52) U.S. Cl. CPC G06F 9/45558; G06F 2009/4557

(57) ABSTRACT

Systems and methods for detecting CPU topology may include executing, by a virtual machine on a host device having a multi-core processing system, a machine-readable process on a core of the host device. The systems and methods may include determining, by the virtual machine, a benchmark metric according to execution of the machine-readable process. The systems and methods may include iteratively executing, by the virtual machine, for different combinations of sockets of the virtual machine, the machine-readable process, to determine execution metrics for each combination of cores in which the machine-readable process is executed. The systems and methods may include determining, by the virtual machine, a hyperthreading arrangement of the host device according to a comparison of the execution metrics to the benchmark metric.

### CROSS-REFERENCE TO RELATED APPLICATIONS

The present application is a continuation of and claims priority to International Application No. PCT/GR2023/000045, titled “METHOD AND SYSTEM FOR DETECTING CPU SMT TOPOLOGY BY EXPLOITING SHARED RESOURCE UTILIZATION,” and filed on Aug. 31, 2023, the contents of which are herein incorporated by reference in its entirety for all purposes.

### FIELD OF THE DISCLOSURE

The present application generally relates to central processing unit (CPU) topology. In particular, the present application relates to systems and methods for detecting topology of a simultaneous multi-threading (SMT) CPU by exploiting shared resource utilization.

### BACKGROUND

CPUs may utilize multi-processor systems. The multi-processor systems may include a socket (e.g., CPU) including multiple independent processing units (e.g., cores). Each core may be capable to provide two or more logical processing units with shared resources, but with the capability of performing two independent tasks (e.g., threads).

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

Some CPUs may increase performance by increasing clock speed. Coupled with other advances in micro-processors (e.g., pipelining, advanced branch prediction), increasing clock speed may result in a corresponding reduction of an instruction cycle (e.g., causing a near linear increase of instructions per second that a CPU can execute with the corresponding increase in clock speed). As time continues since the introduction of CPU technology, CPU frequencies have continued to increase (e.g., at a near exponential rate, from 5 mega hertz (MHz) to 3 giga hertz (GHz) over thirty-four years). However, power density limits have begun to limit clock frequency increases. Thus, multi-processor systems have become more common, with one socket (e.g., CPU) consisting of multiple independent processing units (e.g., cores).

The multi-processor systems supported multiple transistors on a CPU. By doing so, CPU manufacturers can pack additional transistors on the CPU while avoiding hitting (e.g., meeting) power density limits. Thus, enabling a continued increase of CPU performance, where some systems may pack many cores into one CPU (e.g., 60 cores, 128 cores, 192 cores, etc.).

To further increase processing capability of CPUs, some systems employ hyperthreading. Hyperthreading (e.g., SMT) may include a process by which a CPU divides up physical cores into virtual cores (e.g., cores treated as if they are physical cores by an operating system, threads). For example, each core may provide two or more logical processing units (e.g., virtual cores, threads, etc.). The logical processing units may share some resources (e.g., execution units, layer 1 (L1) and layer 2 (L2) caches, system bus, etc.), however, multiple independent tasks (e.g., one per logical processing unit) can be scheduled. Hyperthreading may be beneficial for most workloads. For example, for a task, if a cache miss, a branch prediction failure, or a similar issue occurred, a single-threaded core (e.g., a core with a single logical processing unit) may stall. However, a multi-threaded core may allow the second logical unit to take over (e.g., perform one or more aspects of the task, to carry on the task), resulting in a performance increase (e.g., about 30% increase in some workloads). However, other workloads (e.g., network input/output) may result in a decrease in performance from hyperthreading (e.g., due to the shared resources, due to latency caused by attempting to perform a same action on shared resources rather than using a different logical unit to perform the task). Thus, an operating system or a system administrator may benefit from determining a topology of the CPU (e.g., a hyperthreading topology) to managing workload distribution more efficiently.

For some systems (e.g., for bare metal hardware) the topology of the CPU may be known. However, due to the advent of virtualization, the topology of the CPU may not be given. For example, virtualization frequently obscures the CPU core and thread topology from a virtualized operating system. In some cases, a bare metal manager may determine to provide an app manager with two CPU cores. The bare metal manager may create a virtual machine (VM) and allocate the two cores and respective logical processing units to the VM (e.g., two cores with two processing units each). Because each processing unit may execute a respective logical thread, the view from within the VM may depict (e.g., act like) four cores are available. That is, in some cases, the app manager may not be aware of the topology of the bare metal system as the view of the app manager is from within the VM. Despite appearing as four separate cores in the VM, four tasks may be running on two physical cores on four separate processing units. While the app manager may determine running one task per core is an efficient use of resources, the reality of the situation is a hyperthreading topology where each task is sharing some resources with another task, which may result in a decrease in performance.

Some hypervisors may utilize various techniques in depicting virtual CPU topology. For example, some hypervisors may not expose physical (e.g., bare metal) thread topology, or may not provide sufficient or accurate information about the thread topology to the virtual system. Some hypervisors may be based on configurations to expose host topology to the virtual system; however, the configurations may not be typically used or accessible.

Some systems may include workloads that may deteriorate with hyperthreading. The systems may benefit from performing less processes at a time than is apparently possible based on a number of available processing units. For instance, assuming (n) cores with (2n) logical processing units available (e.g., two per core), performance may deteriorate for running (2n) processes (e.g., one per processing units) rather than (n) processes (e.g., one per core). Because the system may presume that a presented virtual CPU topology is accurate to the physical CPU topology, management of the workload distribution and execution schedule may be inefficient. However, even if the system does not presume the topology and instead performed (n) processes, random placement (e.g., assignment) of the processes may result in a 33% probability of selecting sibling processing units (e.g., resulting in 1× scalability rather than 2× scalability). While some systems may provide recommendations for workarounds (e.g., disable hyperthreading, expose a first processing units in the VM and make sure a second processing units is isolated at the host), the VM may not be able to determine whether the instructions (e.g., recommendations) were followed or executed correctly. For example, if a virtualization host has hyperthreading enabled, the system may determine to execute one process per core, if the core corresponds to a dedicated core in the host. However, the VM cannot determine whether the topology of the virtual host is the same as the physical host. The VM assuming the topology (e.g., assuming that CPUs share processing units on a same host core and spinning two processes) may result in compromised performance (e.g., 50% reduction of performance).

Systems and methods described herein may be configured to determine host topology (e.g., topology of bare metal systems from a view of a virtual system), without relying on topology depiction techniques of the hypervisors. For example, a VM may execute (e.g., run) a machine-readable process (e.g., a micro-workload) against all available CPU pairs to identify presence of hyperthreading. To do so, the VM may identify a list of all possible CPU pairs (e.g., combinations of sockets) of the VM. The VM may iteratively execute the machine-readable process for different pairs of the list. The machine-readable process may be a type of workload configured to decrease in performance when executed with hyperthreading. The VM may determine whether hyperthreading is present for each pair in which the machine-readable process is executed based on a performance of the workload.

An aspect of this disclosure provides a method. The method can include executing, by a VM on a host device having a multi-core processing system, a machine-readable process on a core of the host device. The method can include determining, by the VM, a benchmark metric according to execution of the machine-readable process. The method can include iteratively executing, by the VM, for different combinations of sockets of the VM, the machine-readable process, to determine execution metrics for each combination of cores in which the machine-readable process is executed. The method can include determining, by the VM, a hyperthreading arrangement of the host device according to a comparison of the execution metrics to the benchmark metric.

In some embodiments, the benchmark metric is an execution duration for the machine-readable process on the single core, and wherein the execution metrics are execution durations for the machine-readable process concurrently across two processing units. In some embodiments, executing the machine-readable process on a core of the host device comprises selecting, by the VM, one of the sockets of the VM in which to execute the machine-readable process. In some embodiments, each socket of the VM is executed on a respective core, or a respective processing unit of the core, of the multi-core processing system of the host device. In some embodiments, the machine-readable process is configured for the host device, to increase shared resources and partition resources used by a respective core, to increase an execution duration for instances in which the machine-readable process is executed by two processing units of a single core of the host device. In some embodiments, the shared resources comprise one or more execution ports or a layer 1 cache, and wherein the partition resources comprise one or more special caches.

In some embodiments, the method can include selecting, by the VM, according to the hyperthreading arrangement, sockets of the VM to execute on respective processing units of the multi-core processing system of the host device. In some embodiments, iteratively executing the machine-readable process comprises selecting, by the VM, a first socket and a second socket of the VM. The method can include executing, by the VM, the machine-readable process concurrently on the first socket and the second socket, the first socket executed on a first processing unit of the multi-core processing system and the second socket executed on a second processing unit of the multi-core processing system. The method can include determining, by the VM, first execution metrics for the first processing unit and the second processing unit, responsive to executing the machine-readable process concurrently on the first socket and the second socket. In some embodiments, the benchmark metrics comprise a benchmark execution duration and wherein the first execution metrics comprise a first execution duration. The method can include comparing, by the VM, the first execution duration to the benchmark execution duration. The method can include associating, by the VM, the first processing unit and the second processing unit as being of the same core of the multi-core processing system, responsive to the first execution duration exceeding the benchmark execution duration. In some embodiments, the method can include provisioning, by an intermediary device, the VM to the host device for execution.

Another aspect of this disclosure provides a system. The system can include one or more processors. The processors can be configured to deploy a VM on a host device having a multi-core processing system. The VM can be configured to execute a machine-readable process on a core of the host device The VM can be configured to determine a benchmark metric according to execution of the machine-readable process. The VM can be configured to iteratively execute, for different combinations of sockets of the VM, the machine-readable process, to determine execution metrics for each combination of cores in which the machine-readable process is executed. The VM can be configured to determine a hyperthreading arrangement of the host device according to a comparison of the execution metrics to the benchmark metric.

In some embodiments, the benchmark metric is an execution duration for the machine-readable process on the single core, and wherein the execution metrics are execution durations for the machine-readable process concurrently across two processing units. In some embodiments, wherein to execute the machine-readable process on a core of the host device, the VM can be configured to select one of the sockets of the VM in which to execute the machine-readable process. In some embodiments, each socket of the VM is executed on a respective core, or a respective processing unit of the core, of the multi-core processing system of the host device. In some embodiments, wherein the machine-readable process is configured for the host device, to increase shared resources and partition resources used by a respective core, to increase an execution duration for instances in which the machine-readable process is executed by two processing units of a single core of the host device. In some embodiments, the shared resources comprise one or more execution ports or a layer 1 cache, and wherein the partition resources comprise one or more special caches.

In some embodiments, the VM can be configured to select, according to the hyperthreading arrangement, sockets of the VM to execute on respective processing units of the multi-core processing system of the host device. In some embodiments, to iteratively execute the machine-readable process, the VM can be configured to select a first socket and a second socket of the VM. The VM can be configured to execute the machine-readable process concurrently on the first socket and the second socket, the first socket executed on a first processing unit of the multi-core processing system and the second socket executed on a second processing unit of the multi-core processing system. The VM can be configured to determine first execution metrics for the first processing unit and the second processing unit, responsive to executing the machine-readable process concurrently on the first socket and the second socket. In some embodiments, the benchmark metrics comprise a benchmark execution duration, the first execution metrics comprise a first execution duration. The VM can be configured to compare the first execution duration to the benchmark execution duration. The VM can be configured to associate the first processing unit and the second processing unit as being of the same core of the multi-core processing system, responsive to the first execution duration exceeding the benchmark execution duration.

Another aspect of this disclosure provides a non-transitory computer readable medium. The non-transitory computer readable medium can store instructions that, when executed by one or more processors, cause the one or more processors to deploy a VM on a host device having a multi-core processing system. The VM can be configured to execute a machine-readable process on a core of the host device. The VM can be configured to determine a benchmark metric according to execution of the machine-readable process. The VM can be configured to iteratively execute, for different combinations of sockets of the VM, the machine-readable process, to determine execution metrics for each combination of cores in which the machine-readable process is executed. The VM can be configured to determine a hyperthreading arrangement of the host device according to a comparison of the execution metrics to the benchmark metric.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a diagram of a CPU environment, in accordance with an illustrative embodiment;

FIG. 6 is a diagram of a multi-threaded physical CPU environment, in accordance with an illustrative embodiment;

FIG. 7 is a diagram of the multi-threaded physical CPU environment of FIG. 6 supporting multiple workloads, in accordance with an illustrative embodiment;

FIG. 8 is a diagram of the multi-threaded physical CPU environment of FIG. 6 supporting a virtual machine, in accordance with an illustrative embodiment;

FIG. 9 is a diagram of the multi-threaded physical CPU environment of FIG. 6 executing workloads of the virtual machine if FIG. 8, in accordance with an illustrative embodiment;

FIG. 10 is a diagram of the multi-threaded physical CPU environment of FIG. 6 supporting optimized workloads of the virtual machine of FIG. 8, in accordance with an illustrative embodiment.

FIG. 11 is a flow diagram of a method to detect CPU topology, in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for virtualizing an application delivery controller;
Section D describes embodiments of systems and methods for providing a clustered appliance architecture environment;
Section E describes systems and methods for detecting CPU topology.
Section F describes embodiments of systems and methods for detecting CPU topology.

### A. Network and Computing Environment

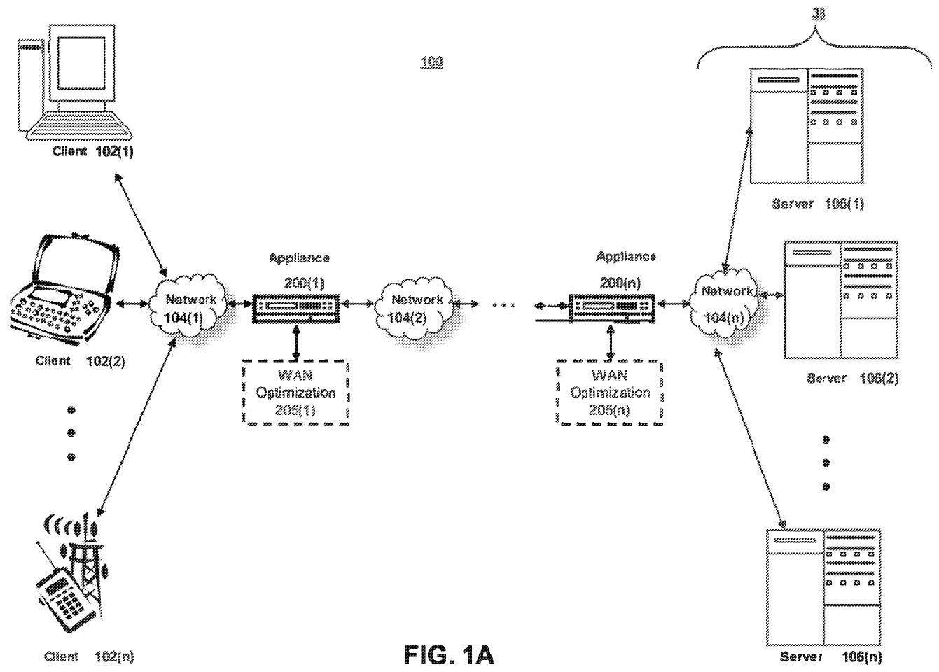

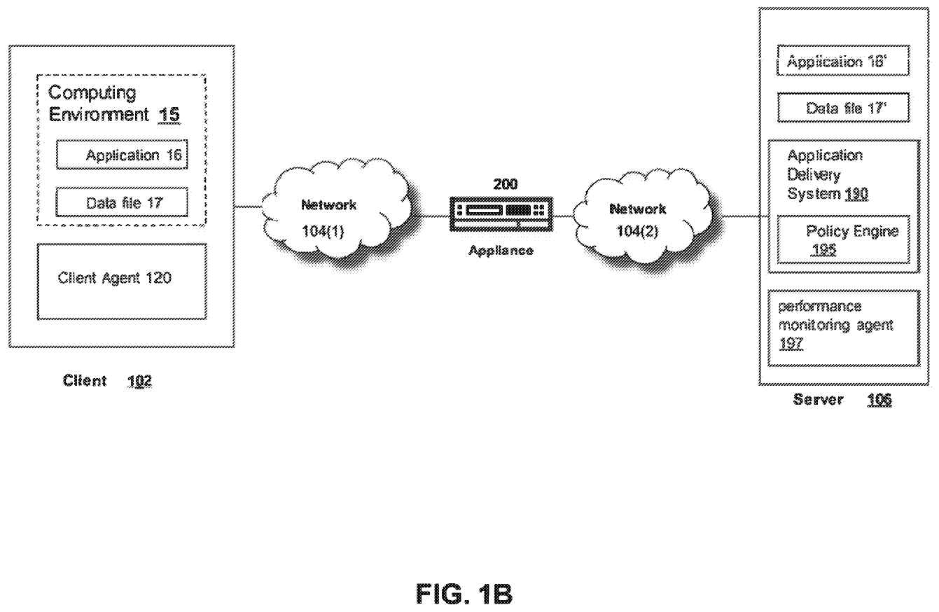

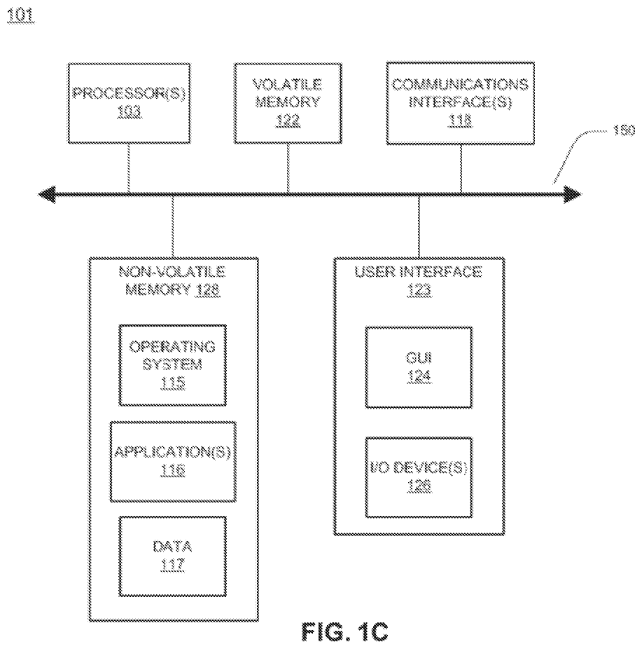

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device (e.g., a network node) such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 102 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

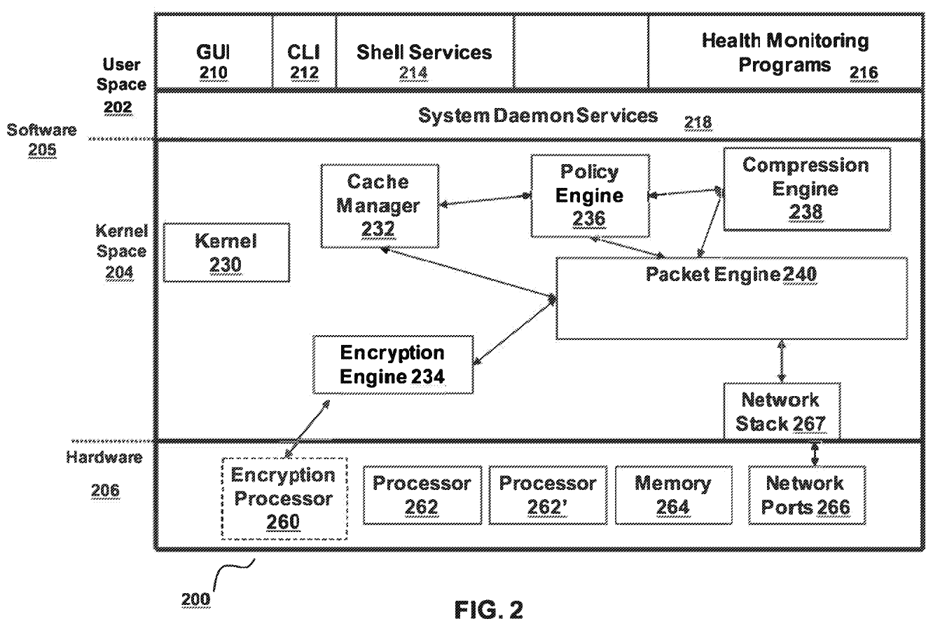

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of appliance 200. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

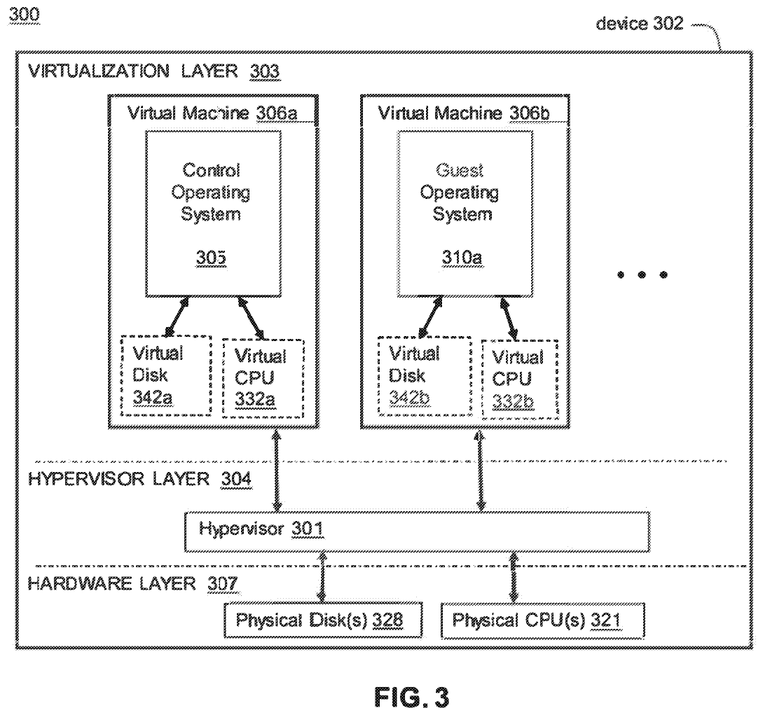

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, FL. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

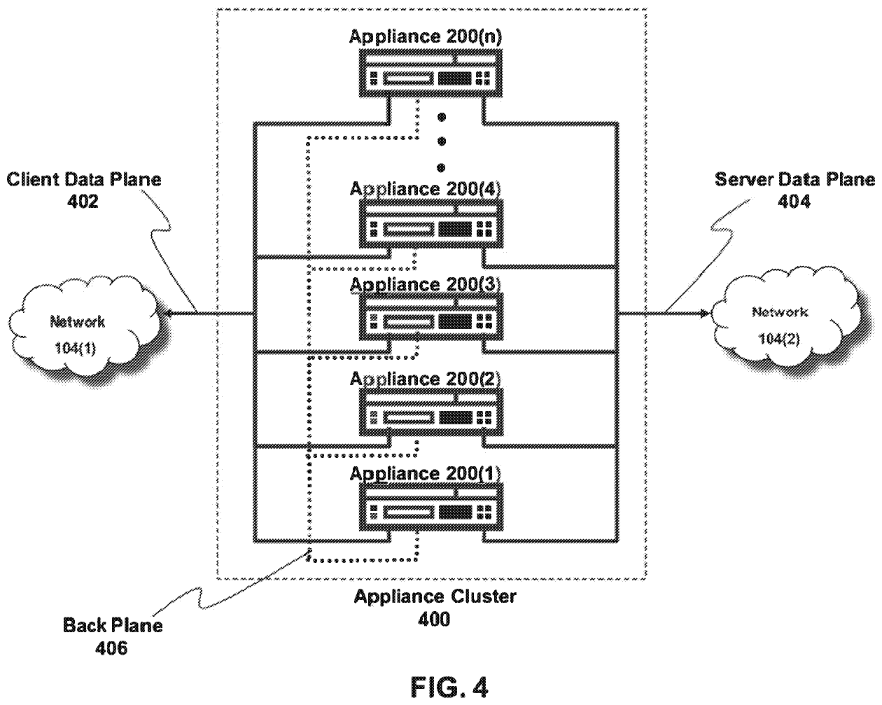

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Detecting CPU Topology

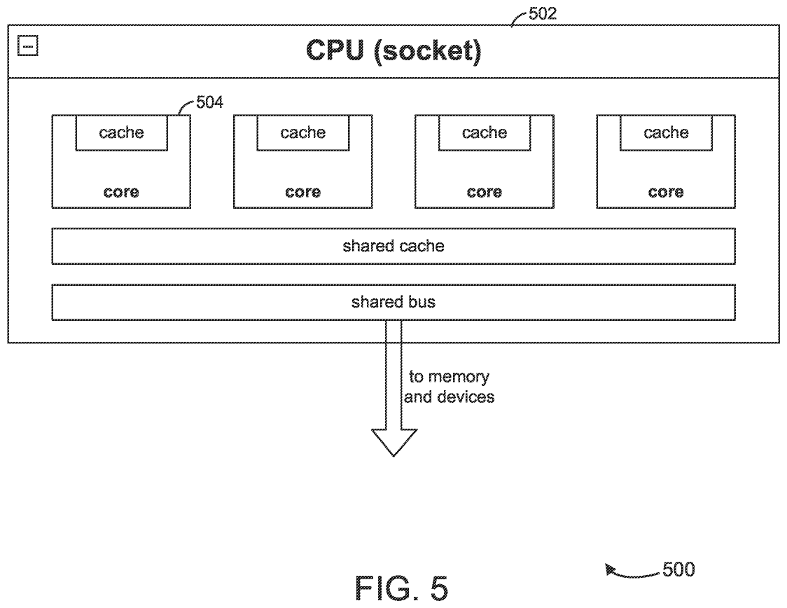

FIG. 5 is a diagram of a CPU environment 500, in accordance with an illustrative embodiment. The CPU environment 500 can include, interface, or otherwise communicate with a CPU 502 (e.g., a socket) and one or more cores 504. In some cases, the CPU environment 500 and the CPU 502 may be respective examples of the hardware layer 307 and the physical processor 321, as described herein with reference to FIG. 3. The CPU 502 may include the cores 504, as well as other physical components that aid in computation (e.g., a shared cache, a shared bus, an input/output interface, etc.). The cores 504 may be independent processing units, each capable of processing a task (e.g., a workload, a thread, a computation, a set of instructions). The cores 504 may each include a cache (e.g., memory). The cores 504 may be in communication with the shared cache, the shared bus, and other components of a device associated with the CPU environment 500 via the shared bus. In some cases, the CPU environment 500 may be an example of a bare metal system.

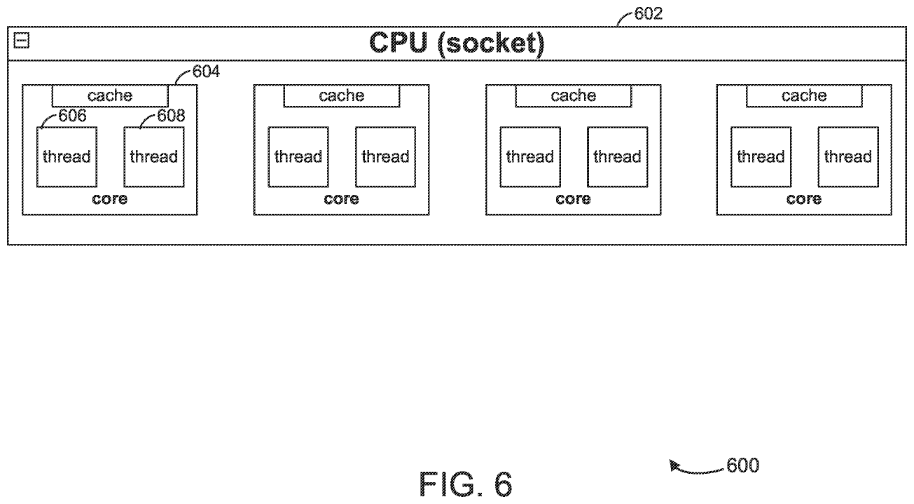

FIG. 6 is a diagram of a CPU environment 600, in accordance with an illustrative embodiment. The CPU environment 600 can include, interface, or otherwise communicate with a CPU 602 (e.g., a socket), one or more cores 604, and multiple processing units 606 and 608. In some cases, the CPU environment 600 and the CPU 602 may be respective examples of the hardware layer 307 and the physical processor 321, as described herein with reference to FIG. 3. The CPU 602 may include the cores 604, as well as other physical components that aid in computation (e.g., a shared cache, a shared bus, an input/output interface, etc.). The CPU 602 may support hyperthreading (e.g., a multi-core, multi-threaded CPU). Hyperthreading, as used herein, refers generally to a deployment or arrangement in which a CPU supports multiple threads (or virtual cores) on a single physical core of the CPU. For example, the CPU 602 may establish or provide multiple “virtual” cores (or threads) on a respective physical core 604 of the CPU 602. A CPU 602 may have, for example, four physical cores 604 which each support or provide two respective virtual cores (or threads), thereby providing eight virtual cores or threads. Similarly, a CPU 602 which has two physical cores 604, each of which are supporting or providing two respective virtual cores or threads, may provide four virtual cores or threads. Each core 604 may support respective processing units 606 and 608 (e.g., logical processing units) with shared resources and capable of performing independent tasks of a respective thread. The processing units 606 and 608 may share or have partitioned execution units, L1/L2 caches, a system bus, execution ports, among other resources.

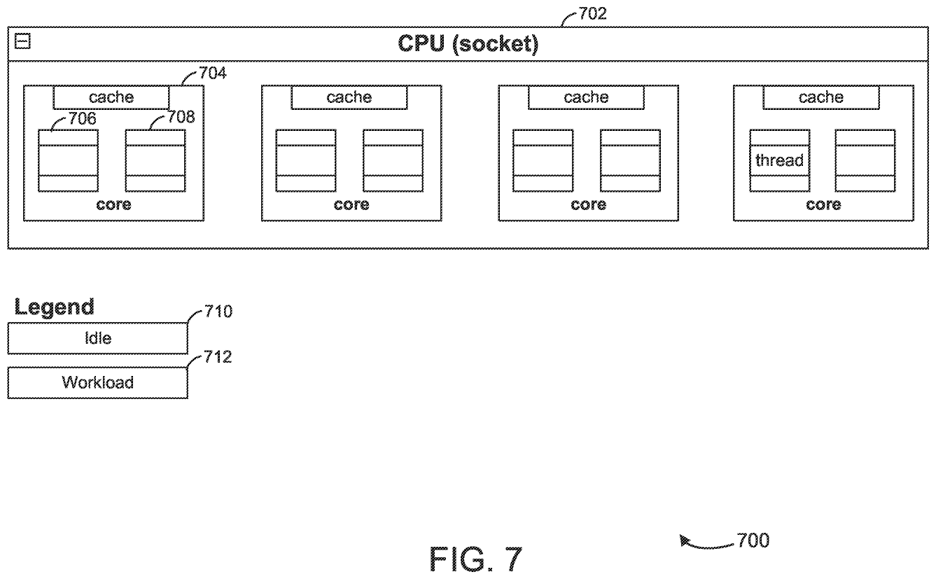

FIG. 7 is a diagram of a CPU environment 700, in accordance with an illustrative embodiment. The CPU environment 700 can include, interface, or otherwise communicate with a CPU 702 (e.g., a socket), one or more cores 704, and multiple processing units 706 and 708. In some cases, the CPU environment 700 and the CPU 702 may be respective examples of the hardware layer 307 and the physical processor 321, as described herein with reference to FIG. 3. The CPU 702 may include the cores 704, as well as other physical components that aid in computation (e.g., a shared cache, a shared bus, an input/output interface, etc.). The CPU 702 may support hyperthreading. Each core 704 may support respective processing units 706 and 708 (e.g., logical processing units) with shared resources and capable of performing independent tasks.

The processing units 706 and 708 may be sibling processing units because they share resources of the same core 704. The processing units 706 and 708 may have multiple states. The states may include an idle state 710 (e.g., waiting, stalling) and an active state 712 (e.g., working, processing). In some implementations, the CPU 702 may increase performance (e.g., execution time, reduce latency) for tasks (e.g., workloads that do not benefit from hyperthreading) by having a first processing unit of each pair of sibling processing units have the idle state 710 and a second processing unit of each pair of sibling processing units have the active state 712, where possible. For example, the processing unit 706 may have the active state 712 and the processing unit 708 may have the idle state 710. In some cases, the CPU 702 (or a CPU manager of the CPU 702) may schedule the tasks that do not benefit from hyperthreading to a core 704 without another task and may schedule tasks that benefit from hyperthreading to a core 704 with another task that benefits from hyperthreading. If a number of tasks is less than a number of cores available, regardless of the type of task, the CPU 702 may schedule the tasks to respective cores 704, such that each sibling processing unit pair is performing no more than a single task.

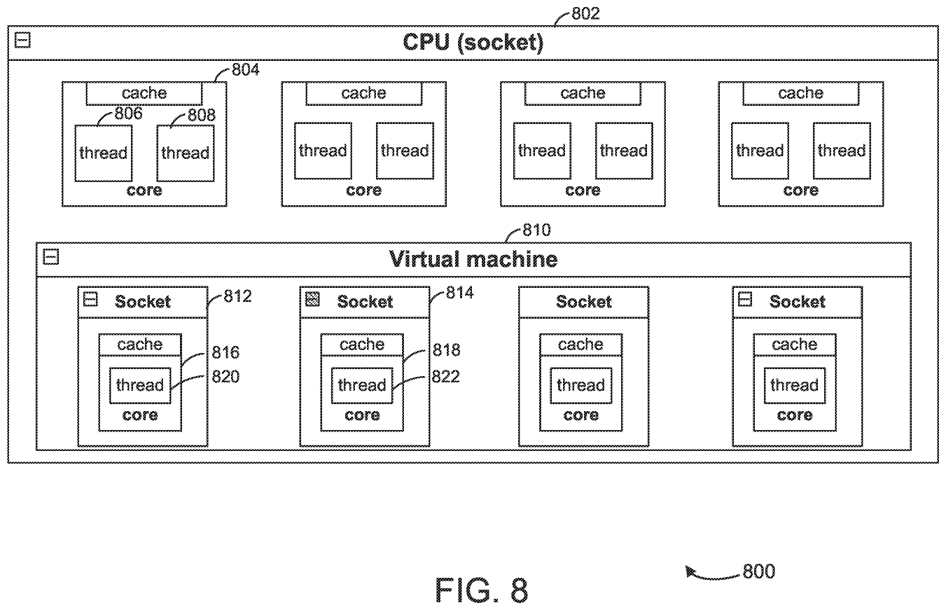

FIG. 8 is a diagram of a CPU environment 800, in accordance with an illustrative embodiment. The CPU environment 800 can include, interface, or otherwise communicate with a CPU 802 (e.g., a socket), one or more cores 804, multiple processing units 806 and 808, a virtual machine (VM) 810, one or more virtual sockets 812 and 814, one or more virtual cores 816 and 818, and one or more virtual processing units 820 and 822. In some cases, the CPU 802, the VM 810, and the sockets 812 and 814 may be respective examples of the physical processor 321, the VMs 306, and the virtual processors 332, as described herein with reference to FIG. 3. The CPU 802 may include the cores 804, as well as other physical components that aid in computation (e.g., a shared cache, a shared bus, an input/output interface, etc.). The CPU 802 may support hyperthreading. Each core 804 may support respective processing units 806 and 808 (e.g., logical processing units) with shared resources and capable of performing independent tasks. The CPU 802 may be an example of a bare metal system and the VM 810 may be an example of a virtual system.

In various embodiments, the VM 810 may execute on and be supported by the CPU 802. For example, the CPU 802 may be or include a physical compute device which is hosting, executing, or otherwise providing a VM 810. The VM 810 may execute on the CPU 802 by executing sockets 812, 814 on respective processing units 806, 808 of a corresponding core 804 of the CPU.

The VM 810 may include the virtual sockets 812 and 814. The virtual socket 812 may include the virtual core 816 and the virtual processing unit 820. The virtual socket 814 may include the virtual core 818 and the virtual processing unit 822. The virtual sockets 812, 814, virtual core 816, and virtual processing unit 820 may be or include virtualized or representative compute components which are supported by corresponding physical compute components of the physical CPU 802. For example, the virtual socket 812 may be assigned to the processing unit 806 of the core 804 and the virtual socket 814 may be assigned to the processing unit 808 of the core 804 such that tasks assigned to the virtual socket 812 may be performed by the processing unit 806 and tasks assigned to the virtual socket 814 may be performed by the processing unit 808. In some cases, the VM 810 may depict a CPU topology different from a topology of the CPU 802. For instance, from a view of the VM 810, the VM 810 may not support hyperthreading. In this regard, each virtual socket of the VM 810 may include a virtual core with a single virtual processing unit. However, the CPU 802 associated with (e.g., executing, supporting, providing) the VM 810 may be a hyperthreading system with multiple (e.g., two) processing units per core 804.

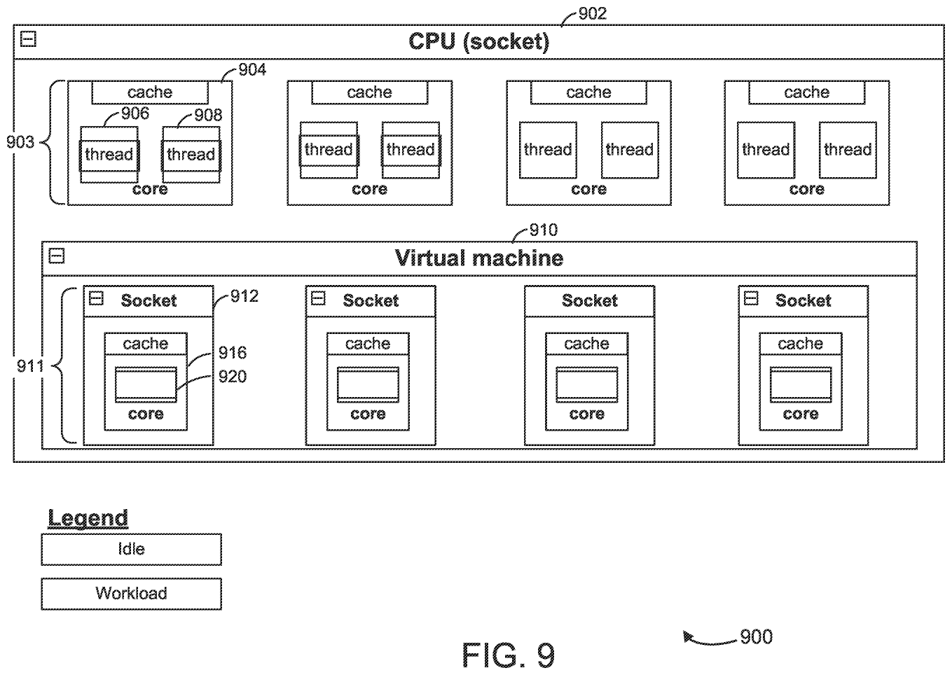

FIG. 9 is a diagram of a CPU environment 900, in accordance with an illustrative embodiment. The CPU environment 900 can include, interface, or otherwise communicate with a CPU 902 (e.g., a socket), one or more cores 904, multiple processing units 906 and 908, a VM 910, one or more virtual sockets 912 and 914, one or more virtual cores 916 and 918, and one or more virtual processing units 920 and 922. In some cases, the CPU 902, the VM 910, and the sockets 912 and 914 may be respective examples of the physical processor 321, the VMs 306, and the virtual processors 332, as described herein with reference to FIG. 3. The CPU 902 may include the cores 904, as well as other physical components that aid in computation (e.g., a shared cache, a shared bus, an input/output interface, etc.) according to a topology 903 (e.g., an arrangement of cores and processing units). The CPU 902 may support hyperthreading. Each core 904 may support respective processing units 906 and 908 (e.g., logical processing units) with shared resources and capable of performing independent tasks. The VM 910 may include the virtual sockets 912 and 914, as well as other components according to a virtual topology 911. The virtual socket 912 may include the virtual core 916 and the virtual processing unit 920. The virtual socket 914 may include the virtual core 918 and the virtual processing unit 922. The processing units 906 and 908 and the virtual processing units 920 and 922 may have multiple states. For example, the processing units 906 and 908 and the virtual processing units 920 and 922 may have a first state (e.g., active, working, processing) and/or a second state (e.g., idle, sleep, dormant).

The VM 910 may include a CPU topology which is different from a topology of the CPU 902. The CPU 902 may obscure (e.g., not provide) a CPU core and thread topology from the VM 910 (e.g., a virtualized operating system). For example, from a view of the VM 910, the topology of the VM 910 may include four virtual sockets 912, each with a virtual core 916 and a virtual processing unit 920. However, the core and thread topology of the CPU 902 may include four cores 904 each with a sibling processing unit pair of processing units 906 and 908. Thus, the VM 910 may determine the VM 910 has four distinct cores spread across four distinct sockets, however, processing is actually performed on two cores 904 using hyperthreading between respective pairs of processing units 906 and 908.

In some cases, the VM 910 (e.g., a manager of the VM 910) may inefficiently assign (e.g., schedule) tasks due to the false topology (e.g., a virtual topology that does not match a physical topology of a corresponding bare metal system). Because the CPU topology of the CPU 902 is unknown to the VM 910, the topology of the VM 910 may correspond to one of: a virtualization host (e.g., physical CPU 902) without hyperthreading or one with hyperthreading disabled; a virtualization host (e.g., physical CPU 902) with hyperthreading enabled, where each virtual core 916 corresponds to a processing unit of a different core in the CPU 902 (e.g., the host); or a virtualization host (e.g., physical CPU 902) with hyperthreading enabled. While the distribution of assignments between the virtual sockets 912 and the processing units 906 and 908 of the CPU 902 are depicted in FIG. 9 according to an example embodiment, it is understood that any assignment of the virtual sockets 912 to any of the processing units 906 and 908 of the CPU 902 is possible. As the VM 910 is unaware of the potential assignments, implicit assumptions of assignments may result in decreased performance when the assumptions are wrong (e.g., different from an actual assignment).

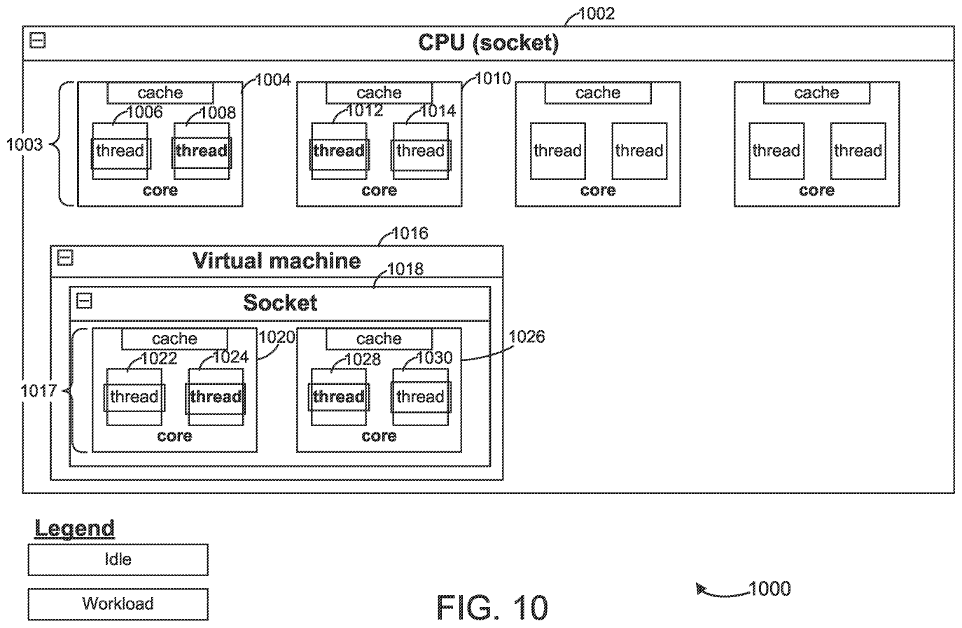

FIG. 10 is a diagram of a CPU environment 1000, in accordance with an illustrative embodiment. The CPU environment 1000 can include, interface, or otherwise communicate with a CPU 1002 (e.g., a socket), one or more cores 1004 and 1010, multiple processing units 1006, 1008, 1012, and 1014, a VM 1016, one or more virtual sockets 1018, one or more virtual cores 1020 and 1026, and one or more virtual processing units 1022, 1024, 1028, and 1030. In some cases, the CPU 1002, the VM 1016, and the socket 1018 may be respective examples of the physical processor 321, the VMs 306, and the virtual processors 332, as described herein with reference to FIG. 3. The CPU 1002 may include the cores 1004 and 1010, as well as other physical components that aid in computation (e.g., a shared cache, a shared bus, an input/output interface, etc.) according to a topology 1003. The CPU 1002 may support hyperthreading. The cores 1004 and 1010 may support respective processing unit pairs 1006 and 1008 and 1012 and 1014 (e.g., logical processing units) with shared resources between the processing unit pairs and capable of performing independent tasks. The VM 1016 may include the virtual socket 1018, as well as other components according to a virtual topology 1017. The virtual socket 1018 may include the virtual cores 1020 and 1026 and the virtual processing unit pairs 1022 and 1024 and 1028 and 1030. The example physical and virtual topologies of the CPU 1002 and the VM 1016 are meant to be illustrative and do not constitute all possible examples of CPU and thread topology. The CPU 1002 and the VM 1016 may include any number of cores, virtual cores, processing units, and virtual processing units in multiple configurations.

In some implementations, the VM 1016 may be unaware of a topology of the CPU 1002 or determine to verify the topology of the CPU 1002. For instance, the CPU 1002 or a manager of the CPU 1002 may obscure the topology or the CPU 1002 may provide insufficient or incorrect information of the topology to the VM 1016. The VM 1016 may determine to identify the topology of the CPU 1002 by identifying a presence of hyperthreading. As described in greater detail below, the VM 1016 may be configured to determine the topology of the CPU 1002 by selectively executing workloads or machine-readable processes on respective processing units 1022, collecting or determining metrics associated with the execution of such workloads/machine-readable processes, and compare those metrics to a benchmark.

The VM 1016 may be configured to execute a machine-readable process. The machine-readable process may include or be a micro-workload, a task, or a set of instructions for a logical processing unit 1022, 1024, 1028, 1030 to execute. The machine-readable process may be configured to exploit shortcomings of shared and partitioned resources on sibling processing unit pairs. CPU resources may be grouped in multiple categories for SMT. Shared resources may include execution port and L1 cache, among other resources. Partitioned resources may include special caches, among other resources. Replicated resources may include generate purpose or vector registers, among other resources. The machine-readable process may be configured to include tasks that are directed towards (e.g., target, utilize) one or more shared or partitioned resources. By focusing on shared or partitioned resources, the machine-readable process may cause a sibling processing unit pair to stall (e.g., delay in execution speed, introduce latency), when the VM 1016 executes the machine-readable process on each processing unit of the pair simultaneously. For example, the machine-readable process may include a CPU instruction corresponding to a specific execution port. Because execution ports are shared, simultaneous execution of a workload including multiple invocations of the instruction on two hyperthreading siblings may result in an increase in latency. When the VM 1016 executes the machine-readable process on two non-sibling cores, the stall (e.g., latency) may be absent.

In some implementations, the VM 1016 may be configured to execute the machine-readable process on a single core of the CPU 1002. The VM 1016 may execute the machine-readable process on any core of the CPU 1002. In some embodiments, the VM 1016 may execute the machine-readable process on any single core, by executing the machine-readable process on a single processing unit 1022, 1024, 1028, 1030. For example, because, in any given hyperthreading arrangement, each processing unit 1022 may be supported by a single physical processing unit 1006, 1008, 1012, 1014 of the CPU 1002, the VM 1016 may execute the machine-readable process on a single core of the CPU 1002 by executing the machine-readable process on any given virtual processing unit (which is correspondingly supported by a respective thread or processing unit of the physical core of the CPU). The VM 1016 may measure a benchmark metric according to execution of the machine-readable process. For example, the VM 1016 may measure an amount of time elapsed to complete execution of the machine-readable process on the core 1004. The amount of time elapsed (or T_{base}) may indicate a threshold (e.g., benchmark) amount of time that a core of the CPU 1002 is expected to complete the machine-readable process without any shared resources. For example, because the machine-readable process is executed on a single processing unit of the VM 1016, which is correspondingly executed on a single processing unit of any given core of the CPU 1002, the processing unit is not sharing any resources with any sibling processing unit of the same core. As such, the processing unit supporting the corresponding processing unit of the VM 1016 which is executing the machine-readable process may not compete for resources, and thus may set a baseline or benchmark for execution of the machine-readable process.

In some embodiments, the VM 1016 may be configured to identify a number of processing units of the VM 1016. The VM 1016 may generate a list of potential unique pairings of the processing units based on the number of processing units. For example, VM 1016 may determine the number of processing units to be four (e.g., the processing units 1022, 1024, 1028, and 1030). The VM 1016 may generate a list of six pairs (e.g., [1022, 1024], [1022, 1028], [1022, 1030], [1024, 1028], [1024, 1030], and [1028, 1030]). The list may be an ordered list, an unordered list, a set of processing units, etc.

The VM 1016 may be configured to iteratively execute the machine-readable process for the pairs of processing units. The VM 1016 may measure an execution metric for each pair of processing units in which the machine-readable process is executed. For instance, the VM 1016 may execute the machine-readable process for each pair of processing units and record an execution time for each processing unit, as depicted in Table 1.

TABLE 1
Execution Time per Processing Unit of Processing Unit Pairs

| VM processing | processing unit#1 | processing unit#2 |
|---|---|---|
| unit pair | performance | performance |
| [1022, 1024] | 2X | 2X |
| [1022, 1028] | X | X |
| [1022, 1030] | X | X |
| [1024, 1028] | X | X |
| [1024, 1030] | X | X |
| [1028, 1030] | 2X | 2X |

In Table 1, “X” may indicate an execution time similar (e.g., same, substantially similar, within a range of values including T_{base}) to T_{base}, and “2X” indicates an execution time similar to twice T_{base}. To do so, the VM 1016 may spawn and bind one thread on each processing unit in a first pair, where the target of each thread is the machine-readable process. The VM 1016 may measure a duration for the threads to finish execution of the machine-readable process (e.g., T_{benchmark1} and T_{benchmark2}).

The VM 1016 may compare the execution metrics to the benchmark metric. For example, the VM 1016 may compare T_{benchmark1} to T_{benchmark2}. The VM 1016 may determine whether T_{benchmark1} and T_{benchmark2} are within a threshold percentage (e.g., 5%) of an average of T_{benchmark1} and T_{benchmark2}. The VM 1016 may compare the average to T_{base}. The VM 1016 may determine whether the comparison between the average and T_{base} satisfies a threshold for being a hyperthreading sibling pair (e.g., the average is +80% of T_{base}). In some cases, for ideal non-sibling pairs, both T_{benchmark1} and T_{benchmark2} may be similar to T_{base} and, for sibling pairs, 2*T_{base}. For example, because non-sibling pairs may have minimal dependencies (e.g., main random-access memory (RAM), L2/L3 caches) and execute in parallel, if the machine-readable process includes minimal (e.g., no, very few) instructions directed towards the dependencies (e.g., minimal memory access), T_{benchmark1} and T_{benchmark2} may be similar to T_{base}. If the machine-readable process includes maximal (e.g., all, mostly) instructions directed towards dependencies of sibling pairs (e.g., execution port), T_{benchmark1} and T_{benchmark2} may be double T_{base} due to CPU stall introduced by shared resources.

An example machine-readable process may include a set of instructions directed towards an execution port. For example, the instructions may include an iterative loop (e.g., a “for” loop, a “while” loop, etc.) of multiple shift instructions (e.g., shift_register_right). The core 1004 may execute the shift instructions in execution port with identifier zero and shift a register by a specified count of bits (e.g., shift_register_right register_a, 1\n). Because the set of instructions target a shared execution port, sibling processing unit pairs may execute the instructions one after another (e.g., consecutively), whereas non-sibling processing unit pairs may execute the instructions in parallel. Additionally, by partially unrolling the main loop, the machine-readable process may introduce contention on instruction fetchers and decoders. In some implementations, other instructions may be included in the machine-readable process (e.g., to introduce contention on branch prediction units and special partitioned caches).

The VM 1016 may determine a hyperthreading arrangement of the CPU 1002 according to the comparison of the execution metrics to the benchmark metric. For example, based on Table 1, the VM 1016 may determine a topology 1003 of the CPU 1002 assigned to the VM 1016 includes the core 1004 with processing units 1006 and 1008 and the core 1010 with processing units 1012 and 1014. The VM 1016 may generate a virtual topology 1017 of the VM 1016 to match the determined topology 1003 of the CPU 1002 (e.g., rather than the virtual topology 911, as described herein with reference to FIG. 9). The VM 1016 may expose the results (e.g., the topologies 1003 and 1017, the various execution times, etc.) to an operating system (OS) facility (e.g., sysctl, as a kernel tunable in Linux). The VM 1016 may schedule one or more subsequent workloads based on the virtual topology 1017 (e.g., a single thread per pair of processing units for workloads that do not benefit from hyperthreading).

In some implementations, the VM 1016 may reduce a workload execution duration (e.g., an amount of time to iteratively execute the machine-readable process for each pair). To do so, the VM 1016 may mark pairs in the list that the VM 1016 has determined are assigned to physical sibling pairs. The VM 1016 may remove (e.g., exclude) all pairs that include either of the processing units of the marked pairs from the list, such that the VM 1016 can skip (e.g., not execute the machine-readable process on) the removed pairs.

In some implementations, the VM 1016 may determine to execute the machine-readable process during a period of time or during a procedure. For example, the VM 1016 may execute the machine-readable process on system boot (e.g., system boot in kernel space). During system boot, other programs may not schedule virtual CPUs. Thus, priority may be given to executing the machine-readable process. By ensuring other programs may not use the virtual CPUs, the execution times of the processing unit pairs may be more accurate (e.g., reduce noise, reduce false positives).

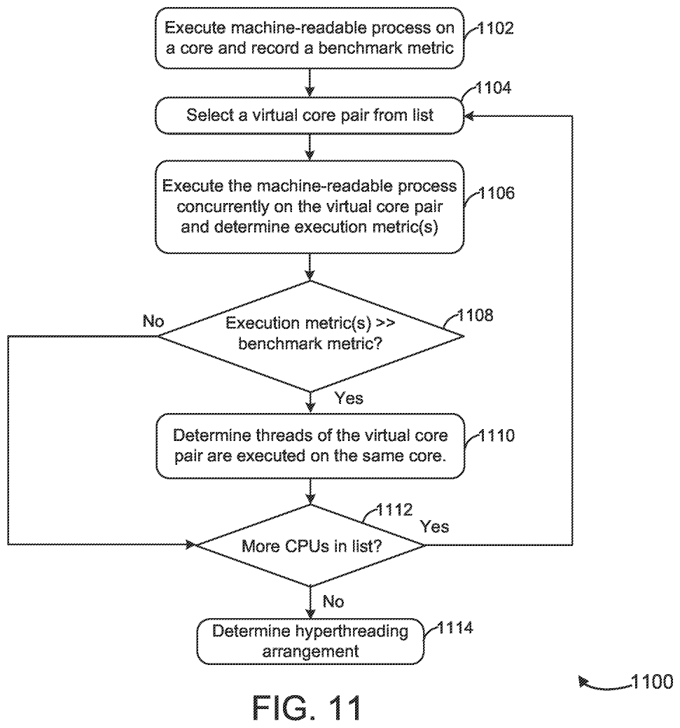

FIG. 11 is a flow diagram of a method 1100 to generate recommendations to improve a performance of a tenant data processing system. The method 1100 can be performed by one or more system, component, or module depicted in FIGS. 1-10, including, for example, a VM, a CPU (e.g., a host device), a multi-core processing system, a core, an application, a server, a client, or a cloud system in a network. In some cases, an intermediary device may provision the virtual machine to the host device for execution. While the steps of the method 1100 are described according to an order, any subset or all of the steps may be performed in any order, simultaneously, or omitted. In brief summary, the method 1100 includes operation 1102, at which a VM can execute a machine-readable process and record a benchmark metric. At operation 1104, the VM can select a virtual core pair from a list. At operation 1106, the VM can execute the machine-readable process concurrently on the virtual core pair and determine one or more execution metric(s). At operation 1108, the VM can determine whether the execution metric(s) are greater than the benchmark metric. At operation 1110, the VM can determine threads of the virtual core pair are executed on the same core. At operation 1112, the VM can determine whether there are more virtual core pairs in the list. At operation 1114, the VM can determine a topology of a physical CPU and terminate the method.

At operation 1102, a VM may execute a machine-readable process and record a benchmark metric. The VM may be on a host device having a multi-core processing system. The VM may execute the machine-readable process on a core of the host device. In some cases, the core may be a random core (e.g., randomly selected, selected by the host device from a list of cores assigned to or provided by the VM). In some cases, the VM may select one of the cores of the VM in which to execute the machine-readable process, where each core of the VM is executed on a respective core or a respective thread of the core of the multi-core processing system of the host device. The VM may determine the benchmark metric according to execution of the machine-readable process. The benchmark metric may include an execution duration for the machine-readable process on a single core of the host device.

In some implementations, the machine-readable process may be configured for the host device. In some embodiments, the VM may configure the machine-readable process based on specifications of the host device. In some embodiments, the VM may retrieve, access, or otherwise receive the machine-readable process from one or more data stores (e.g., remote stores, databases, servers), based on or according to the host device (e.g., a type of host device, a make/model of the host device, a serial no. or unique identifier of the host device, etc.). The machine-readable process may be configured for the host device to increase shared resources and partition resources used by a respective core. The machine-readable process may be configured for the host device to increase an execution duration for instances in which the machine-readable process is executed by two threads of a single core of the host device. In some cases, the shared resources include one or more execution ports or an L1 cache and the partition resources include one or more special caches.

At operation 1104, the VM can select a virtual core pair from a list. In some embodiments, the VM can generate, determine, derive, or otherwise identify a list of cores of the VM. The list may include combinations, iterations, groupings, pairs, etc. of cores (e.g., all possible unique pair combinations based on a number of cores in the VM). The VM can iteratively select a pair from the list on which to execute the machine-readable process, as described in greater detail below.

At operation 1106, the VM can iteratively execute the machine-readable process for the different combinations of cores of the VM, to determine execution metrics for each combination of cores in which the machine-readable process is executed. For example, the VM can select a first core and a second core of the virtual machine (e.g., based on the list). The VM can concurrently execute the machine-readable process on the first virtual core and the second virtual core. The first core may be executed on a first thread of the multi-core processing system and the second core may be executed on a second thread of the multi-core processing system. The VM may determine execution metrics for the first thread and the second thread responsive to executing the machine-readable process concurrently on the first core and the second core. In some embodiments, the VM may record a first execution metric and a second execution metric for each of the processing units of the first virtual core pair. The execution metrics may be execution durations for the machine-readable process concurrently across two threads.

The VM can compare the execution metrics to the benchmark metric (e.g., the first execution duration to the benchmark execution duration). For example, at operation 1108, the VM can determine whether execution metric(s) are greater than (e.g., much greater than, double, more than +80%) the benchmark metric. If the execution metric(s) are not greater than the benchmark metric, the VM may determine the first virtual core pair is a non-sibling pair and continue to operation 1112. If the execution metric(s) are greater than the benchmark metric, the VM may continue to operation 1110. At operation 1110, the VM may associate the first thread and the second thread as being of the same core of the multi-core processing system, responsive to the execution duration exceeding the benchmark execution duration. For example, the VM may determine the first virtual core pair is a sibling pair (e.g., the processing units of the first virtual core pair are on the same core) and mark the first virtual core pair as a sibling pair. Responsive to the determination of the sibling pair, in some implementations, the VM may remove the first virtual core pair from the list.

At operation 1112, the VM can determine whether there are more virtual core pairs in the list. If there are more virtual core pairs in the list that the VM has not executed the machine-readable process, or that the VM has not removed from the list, the VM may continue back to operation 1104, to continue selecting virtual core pairs from the list. If the VM has executed the machine-readable process for the virtual core pairs in the list (e.g., for each of the iterations/combinations/etc. of virtual core pairs), the VM may continue to operation 1114. At operation 1114, the VM can determine a hyperthreading arrangement (e.g., a topology) of the host device. The VM can determine the hyperthreading arrangement based on the marked sibling pairs from operation 1110. The VM can select, according to the hyperthreading arrangement, cores of the virtual machine to execute on respective threads of the multi-core processing system of the host device.

### F. Example Embodiments for Detecting CPU Topology

The following examples pertain to further example embodiments, from which permutations and configurations will be apparent.

Example 1 includes a method. The method can include executing, by a virtual machine on a host device having a multi-core processing system, a machine-readable process on a core of the host device. The method can include determining, by the virtual machine, a benchmark metric according to execution of the machine-readable process. The method can include iteratively executing, by the virtual machine, for different combinations of sockets of the virtual machine, the machine-readable process, to determine execution metrics for each combination of cores in which the machine-readable process is executed. The method can include determining, by the virtual machine, a hyperthreading arrangement of the host device according to a comparison of the execution metrics to the benchmark metric.

Example 2 includes the subject matter of Example 1, wherein the benchmark metric is an execution duration for the machine-readable process on the single core, and wherein the execution metrics are execution durations for the machine-readable process concurrently across two threads.

Example 3 includes the subject matter of any of examples 1 or 2, wherein executing the machine-readable process on a core of the host device comprises selecting, by the virtual machine, one of the sockets of the virtual machine in which to execute the machine-readable process.

Example 4 includes the subject matter of any of examples 1 to 3, wherein each socket of the virtual machine is executed on a respective core, or a respective thread of the core, of the multi-core processing system of the host device.

Example 5 includes the subject matter of any of examples 1 to 4, wherein the machine-readable process is configured for the host device, to increase shared resources and partition resources used by a respective core, to increase an execution duration for instances in which the machine-readable process is executed by two threads of a single core of the host device.

Example 6 includes the subject matter of any of examples 1 to 5, wherein the shared resources comprise one or more execution ports or a layer 1 cache, and wherein the partition resources comprise one or more special caches.

Example 7 includes the subject matter of any of examples 1 to 6, the method further comprising selecting, by the virtual machine, according to the hyperthreading arrangement, sockets of the virtual machine to execute on respective threads of the multi-core processing system of the host device.

Example 8 includes the subject matter of any of examples 1 to 7, wherein iteratively executing the machine-readable process comprises selecting, by the virtual machine, a first socket and a second socket of the virtual machine. The method further comprises executing, by the virtual machine, the machine-readable process concurrently on the first socket and the second socket, the first socket executed on a first thread of the multi-core processing system and the second socket executed on a second thread of the multi-core processing system. The method further comprises determining, by the virtual machine, first execution metrics for the first thread and the second thread, responsive to executing the machine-readable process concurrently on the first socket and the second socket.

Example 9 includes the subject matter of any of examples 1 to 8, wherein the benchmark metrics comprise a benchmark execution duration and wherein the first execution metrics comprise a first execution duration. The method further comprises comparing, by the virtual machine, the first execution duration to the benchmark execution duration. The method further comprises associating, by the virtual machine, the first thread and the second thread as being of the same core of the multi-core processing system, responsive to the first execution duration exceeding the benchmark execution duration. In some embodiments, the method can include provisioning, by an intermediary device, the virtual machine to the host device for execution.

Example 10 includes the subject matter of any of examples 1 to 9, wherein the method further comprises provisioning, by an intermediary device, the virtual machine to the host device for execution.

Example 11 includes a system. The system includes one or more processors. The processors are configured to deploy a virtual machine on a host device having a multi-core processing system. The virtual machine configured to execute a machine-readable process on a core of the host device The virtual machine configured to determine a benchmark metric according to execution of the machine-readable process. The virtual machine configured to iteratively execute, for different combinations of sockets of the virtual machine, the machine-readable process, to determine execution metrics for each combination of cores in which the machine-readable process is executed. The virtual machine configured to determine a hyperthreading arrangement of the host device according to a comparison of the execution metrics to the benchmark metric.

Example 12 includes the subject matter of Example 11, wherein the benchmark metric is an execution duration for the machine-readable process on the single core, and wherein the execution metrics are execution durations for the machine-readable process concurrently across two threads.

Example 13 includes the subject matter of examples 11 or 12, wherein to execute the machine-readable process on a core of the host device, the virtual machine can be configured to select one of the sockets of the virtual machine in which to execute the machine-readable process.

Example 14 includes the subject matter of any of examples 11 to 13, wherein each socket of the virtual machine is executed on a respective core, or a respective thread of the core, of the multi-core processing system of the host device.

Example 15 includes the subject matter of any of examples 11 to 14, wherein the machine-readable process is configured for the host device, to increase shared resources and partition resources used by a respective core, to increase an execution duration for instances in which the machine-readable process is executed by two threads of a single core of the host device.

Example 16 includes the subject matter of any of examples 11 to 15, wherein the shared resources comprise one or more execution ports or a layer 1 cache, and wherein the partition resources comprise one or more special caches.

Example 17 includes the subject matter of any of examples 11 to 16, wherein the virtual machine is further configured to select, according to the hyperthreading arrangement, sockets of the virtual machine to execute on respective threads of the multi-core processing system of the host device.

Example 18 includes the subject matter of any of examples 11 to 17, wherein to iteratively execute the machine-readable process, the virtual machine is further configured to select a first socket and a second socket of the virtual machine. The virtual machine is further configured to execute the machine-readable process concurrently on the first socket and the second socket, the first socket executed on a first thread of the multi-core processing system and the second socket executed on a second thread of the multi-core processing system. The virtual machine is further configured to determine first execution metrics for the first thread and the second thread, responsive to executing the machine-readable process concurrently on the first socket and the second socket.

Example 19 includes the subject matter of any of examples 11 to 18, wherein the benchmark metrics comprise a benchmark execution duration, the first execution metrics comprise a first execution duration. The virtual machine is further configured to compare the first execution duration to the benchmark execution duration. The virtual machine is further configured to associate the first thread and the second thread as being of the same core of the multi-core processing system, responsive to the first execution duration exceeding the benchmark execution duration.

Example 20 includes a non-transitory computer readable medium storing instructions that, when executed by one or more processors, cause the one or more processors to deploy a virtual machine on a host device having a multi-core processing system. The virtual machine configured to execute a machine-readable process on a core of the host device. The virtual machine configured to determine a benchmark metric according to execution of the machine-readable process. The virtual machine configured to iteratively execute, for different combinations of sockets of the virtual machine, the machine-readable process, to determine execution metrics for each combination of cores in which the machine-readable process is executed. The virtual machine configured to determine a hyperthreading arrangement of the host device according to a comparison of the execution metrics to the benchmark metric.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus, or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents. References to “or” can be construed as inclusive so that any terms described using “or” can indicate any of a single, more than one, and all of the described terms. For example, a reference to “at least one of ‘A’ and ‘B’” can include only “A,” only “B,” as well as both “A” and “B.” Such references used in conjunction with “comprising” or other open terminology can include additional items.

It will be further understood that various changes in the details, materials, and arrangements of the parts that have been described and illustrated herein may be made by those skilled in the art without departing from the scope of the following claims.

What is claimed is:

1. A method comprising:
executing, by a virtual machine on a host device having a multi-core processing system, a machine-readable process on a core of the host device;
determining, by the virtual machine, a benchmark metric according to execution of the machine-readable process;
iteratively executing, by the virtual machine, for different combinations of cores of the virtual machine, the machine-readable process, to determine execution metrics for each combination of cores in which the machine-readable process is executed; and
determining, by the virtual machine, a hyperthreading arrangement of the host device according to a comparison of the execution metrics to the benchmark metric.

2. The method of claim 1, wherein the benchmark metric is an execution duration for the machine-readable process on a single core, and wherein the execution metrics are execution durations for the machine-readable process concurrently across two threads.

3. The method of claim 1, wherein executing the machine-readable process on the core of the host device comprises selecting, by the virtual machine, one of the cores of the virtual machine in which to execute the machine-readable process.

4. The method of claim 1, wherein each core of the virtual machine is executed on a respective core, or a respective thread of the core, of the multi-core processing system of the host device.

5. The method of claim 1, wherein the machine-readable process is configured for the host device, to increase shared resources and partition resources used by a respective core, to increase an execution duration for instances in which the machine-readable process is executed by two threads of a single core of the host device.

6. The method of claim 5, wherein the shared resources comprise one or more execution ports or a layer 1 cache, and wherein the partition resources comprise one or more special caches.

7. The method of claim 1, further comprising:
selecting, by the virtual machine, according to the hyperthreading arrangement, cores of the virtual machine to execute on respective threads of the multi-core processing system of the host device.

8. The method of claim 1, wherein iteratively executing the machine-readable process comprises:
selecting, by the virtual machine, a first core and a second core of the virtual machine;
executing, by the virtual machine, the machine-readable process concurrently on the first core and the second core, the first core executed on a first thread of the multi-core processing system and the second core executed on a second thread of the multi-core processing system; and
determining, by the virtual machine, first execution metrics for the first thread and the second thread, responsive to executing the machine-readable process concurrently on the first core and the second core.

9. The method of claim 8, wherein the benchmark metrics comprise a benchmark execution duration and wherein the first execution metrics comprise a first execution duration, the method further comprising:
comparing, by the virtual machine, the first execution duration to the benchmark execution duration; and
associating, by the virtual machine, the first thread and the second thread as being of the same core of the multi-core processing system, responsive to the first execution duration exceeding the benchmark execution duration.

10. The method of claim 1, further comprising provisioning, by an intermediary device, the virtual machine to the host device for execution.

11. A system comprising:
one or more processors configured to deploy a virtual machine on a host device having a multi-core processing system, the virtual machine configured to:
execute a machine-readable process on a core of the host device;
determine a benchmark metric according to execution of the machine-readable process;
iteratively execute, for different combinations of cores of the virtual machine, the machine-readable process, to determine execution metrics for each combination of cores in which the machine-readable process is executed; and
determine a hyperthreading arrangement of the host device according to a comparison of the execution metrics to the benchmark metric.

12. The system of claim 11, wherein the benchmark metric is an execution duration for the machine-readable process on the single core, and wherein the execution metrics are execution durations for the machine-readable process concurrently across two threads.

13. The system of claim 11, wherein to execute the machine-readable process on a core of the host device, the virtual machine is configured to select one of the cores of the virtual machine in which to execute the machine-readable process.

14. The system of claim 11, wherein each core of the virtual machine is executed on a respective core, or a respective thread of the core, of the multi-core processing system of the host device.

15. The system of claim 11, wherein the machine-readable process is configured for the host device, to increase shared resources and partition resources used by a respective core, to increase an execution duration for instances in which the machine-readable process is executed by two threads of a single core of the host device.

16. The system of claim 15, wherein the shared resources comprise one or more execution ports or a layer 1 cache, and wherein the partition resources comprise one or more special caches.

17. The system of claim 11, wherein the virtual machine is further configured to:
select, according to the hyperthreading arrangement, cores of the virtual machine to execute on respective threads of the multi-core processing system of the host device.

18. The system of claim 11, wherein, to iteratively executing the machine-readable process, the virtual machine is configured to:
select a first core and a second core of the virtual machine;
execute the machine-readable process concurrently on the first core and the second core, the first core executed on a first thread of the multi-core processing system and the second core executed on a second thread of the multi-core processing system; and
determine first execution metrics for the first thread and the second thread, responsive to executing the machine-readable process concurrently on the first core and the second core.

19. The system of claim 18, wherein the benchmark metrics comprise a benchmark execution duration, the first execution metrics comprise a first execution duration, and wherein the virtual machine is further configured to:
compare the first execution duration to the benchmark execution duration; and
associate the first thread and the second thread as being of the same core of the multi-core processing system, responsive to the first execution duration exceeding the benchmark execution duration.

20. A non-transitory computer readable medium storing instructions that, when executed by one or more processors, cause the one or more processors to:
deploy a virtual machine on a host device having a multi-core processing system, the virtual machine configured to:
execute a machine-readable process on a core of the host device;
determine a benchmark metric according to execution of the machine-readable process;
iteratively execute, for different combinations of cores of the virtual machine, the machine-readable process, to determine execution metrics for each combination of cores in which the machine-readable process is executed; and
determine a hyperthreading arrangement of the host device according to a comparison of the execution metrics to the benchmark metric.
